(19) United States
(12) Patent Application Publication
(10) Pub. No.: US 2026/0058269 A1
(43) Pub. Date: Feb. 26, 2026

(54) MULTIFUNCTIONAL MOBILE ENERGY STORAGE BOX

(71) Applicant: GUANGZHOU GUANGSHEN ELECTRIC PRODUCE CO., LTD., Guangzhou (CN)

(72) Inventor: Xinbing WANG, Guangzhou (CN)

(73) Assignee: GUANGZHOU GUANGSHEN ELECTRIC PRODUCE CO., LTD., Guangzhou (CN)

(21) Appl. No.: 19/373,816

(22) Filed: Oct. 30, 2025

Related U.S. Application Data
(63) Continuation of application No. PCT/CN2024/089248, filed on Apr. 23, 2024.

(30) Foreign Application Priority Data
May 8, 2023 (CN) 202310510076.8

(51) Int. Cl. H01M 50/202; H01M 10/613; H01M 10/63; H01M 10/6563; H01M 10/6569; H01M 50/231; H01M 50/244; H01M 50/264

(52) U.S. Cl. CPC H01M 50/202; H01M 10/63; H01M 10/6563; H01M 10/6569; H01M 50/231; H01M 50/244; H01M 50/264; H01M 10/613; H01M 2220/30

(57) ABSTRACT

A multifunctional mobile energy storage box, including an upper cover, a casing, an inner liner, an energy storage unit, an inverter unit, a refrigeration unit, a power socket unit, a thermal management unit, and a main control unit, where the upper cover openably and closably covers an upper end of the casing, and the inner liner is placed in the casing; the refrigeration unit comprises a compressor, a condenser, and an evaporator, and the evaporator is arranged on an outside wall of the inner liner or placed on an inside wall of the casing; the power socket unit comprises a socket of at least one external electrical device; and the main control unit detects parameters of the energy storage unit, the inverter unit and the refrigeration unit in real time, controls switching on, shutdown and operation of the refrigeration unit and the power socket unit according to the detected parameters.

### CROSS-REFERENCE TO RELATED APPLICATIONS

The application claims priority to Chinese patent application No. 202310510076.8, filed on May 8, 2023, the entire contents of which are incorporated herein by reference.

### TECHNICAL FIELD

The present disclosure relates to the technical field of household appliances, in particular to a multifunctional mobile energy storage box.

### BACKGROUND

With the improvement of living standards, more and more people advocate going outdoors to get in touch with nature during weekends or holidays, and relax and meet friends in parks, beaches, seaside, grasslands and other places. Fruit, drinks and cooking ingredients will inevitably be needed. It involves the storage and cooking of fruit, drinks and ingredients. For the storage of fruit, drinks and ingredients, most people currently use a separate car refrigerator or outdoor refrigerator, and for the cooking of ingredients, they use a separate cooker or oven, which is then powered by a small tank of natural gas or a high-power mobile power supply outdoors. Coupled with other auxiliary needs such as night lighting or playback, charging of mobile devices, etc., more equipment needs to be prepared, which can easily lead to omissions, and more equipment will also take up more space. It cannot meet people's increasing demand for light-weight and convenient outdoor leisure and relaxation experience.

### SUMMARY

The purpose of the present disclosure is to provide a multifunctional mobile energy storage box that can not only meet the needs of food storage but also supply power to high-power electrical devices such as cooking and barbecue utensils. Meanwhile, it can detect power consumption conditions in real time and turn off or switch on the power supply of the high-power electrical devices according to the power consumption conditions to ensure power supply for food storage, so as to solve the problems raised in the above background.

To achieve the above object, the present disclosure adopts the following technical solutions:

A multifunctional mobile energy storage box, including an upper cover, a casing, an inner liner, an energy storage unit, an inverter unit, a refrigeration unit, an power socket unit, a thermal management unit, and a main control unit, where the upper cover openably and closably covers an upper end of the casing, and the inner liner is placed in the casing; the refrigeration unit comprises a compressor, a condenser, and an evaporator, and the evaporator is arranged on an outside wall of the inner liner or placed on an inside wall of the casing; the power socket unit comprises a socket of at least one external electrical device; and the main control unit detects parameters of the energy storage unit, the inverter unit and the refrigeration unit in real time, and controls switching-on, shutdown and operation of the refrigeration unit and the power socket unit according to the detected parameters.

Specifically, the casing includes an upper casing, a lower casing, and a bottom casing, a lower part of the inner liner is placed in the lower casing and an upper port is sleeved in the upper casing. Preferably, the upper casing and the lower casing are integrally formed, and the bottom casing is fixedly mounted at the bottom of the lower casing.

Further, a cavity is provided on one side of the lower casing or the upper casing, and the compressor and the condenser of the refrigeration unit, the inverter unit, and the power socket unit are mounted in the cavity and covered by an outer cover.

Further, the thermal management unit comprises a cooling fan, an air inlet, and an air outlet, the air inlet is disposed at one end of the bottom casing or on the upper casing, the air outlet is disposed on a side wall of the outer cover close to the condenser or on the upper casing, and the main control unit is connected to the cooling fan and turns on or shuts down the cooling fan or adjusts a rotational speed of the cooling fan according to the detected parameters of the inverter unit, the energy storage unit and the refrigeration unit.

Further, a bottom surface of the lower casing is provided with at least one run-through ventilation duct, and the air inlet, the ventilation duct and the air outlet constitute a heat dissipation passage.

Further, the bottom casing is provided with a storage groove, a mounting plate is provided in the storage groove, a clip is provided on the mounting plate, and the energy storage unit is clamped in the storage groove by the clip.

Further, a bottom surface of the storage groove of the bottom casing is provided with a convex rib, and the energy storage unit is placed on the convex rib and separated from the bottom surface of the storage groove by a gap.

Further, the energy storage unit is also provided with an energy storage unit protection board, and the charging and power supply of the energy storage unit are controlled by the energy storage unit protection board.

Further, a lighting unit is also provided, and the main control unit is electrically connected to the lighting unit to control the lighting unit to be turned on and off or adjust the brightness of the lighting unit.

The present disclosure has the beneficial effects: The refrigeration unit and the power socket unit are powered by the energy storage unit, so that the refrigeration unit can store food in a refrigerated state and the power socket unit can supply power to high-power electrical devices such as cooking and barbecue utensils. Meanwhile, the main control unit detects the parameters of the refrigeration unit, the inverter unit and the energy storage unit in real time, and controls the switching on, shutdown and operation of the refrigeration unit and the power socket unit according to the detected parameters to ensure power supply for food storage. It can also meet auxiliary power supply needs such as lighting or playback, and charging of mobile devices, and it takes up little space, meeting people's needs for light-weight and convenient outdoor leisure and relaxation.

### BRIEF DESCRIPTION OF DRAWINGS

The accompanying drawings further illustrate the present disclosure, but the embodiments in the accompanying drawings do not constitute any limitation to the present disclosure.

FIG. 1 is a schematic diagram of a three-dimensional structure of a multifunctional mobile energy storage box according to the present disclosure;

FIG. 2 is a schematic diagram of a three-dimensional structure of a back side of a multifunctional mobile energy storage box according to the present disclosure;

FIG. 3 is a schematic structural diagram of a multifunctional mobile energy storage box without an outer cover according to the present disclosure;

FIG. 4 is a schematic structural diagram of a multifunctional mobile energy storage box without an outer cover and a lower casing according to the present disclosure;

FIG. 5 is a schematic structural diagram of a multifunctional mobile energy storage box without a casing and an upper cover according to the present disclosure;

FIG. 6 is a schematic structural diagram of a lower casing;

FIG. 7 is a schematic structural diagram of a bottom casing; and

FIG. 8 is a mounting schematic diagram of a bottom casing and an energy storage unit as well as an inverter unit, a refrigeration unit, and a power socket unit.

### DETAILED DESCRIPTION OF THE EMBODIMENTS

In order to make the purpose, technical solutions and advantages of the present disclosure clearer, the technical solutions of the present disclosure will be further clearly and completely described below in conjunction with the embodiments of the present disclosure. It should be noted that the described embodiments are only part of the embodiments of the present disclosure, rather than all the embodiments. Based on the embodiments of the present disclosure, all other embodiments obtained by a person ordinary skill in the art without making any creative work shall fall within the scope of protection of the present disclosure.

It should be understood that orientations or positional relationships indicated by terms “upper”, “lower”, “front”, “back”, “left”, “right”, etc. are based on the orientations or positional relationships shown in the accompanying drawings, the terms are merely intended to facilitate the descriptions of the present disclosure and simplify the descriptions, rather than indicating or implying that a device or element referred to must have a specific orientation, be constructed and operate in a specific orientation, and therefore should not be understood as limiting the present disclosure.

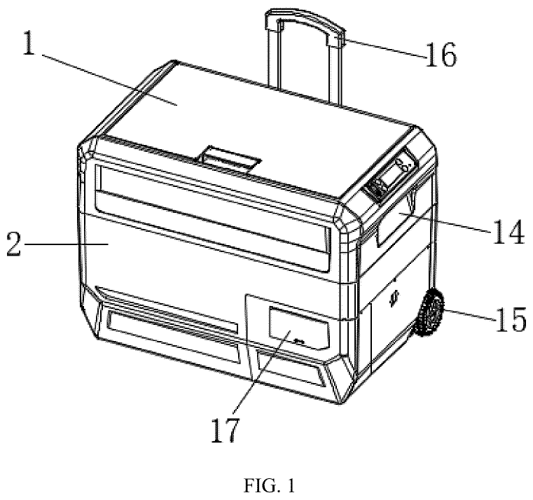

As shown in FIGS. 1 to 4, the present disclosure provides a multifunctional mobile energy storage box, which includes an upper cover 1, a casing 2, an inner liner 3, an energy storage unit 4, an inverter unit 5, a refrigeration unit 6, a power socket unit 7, a thermal management unit, and a main control unit 8.

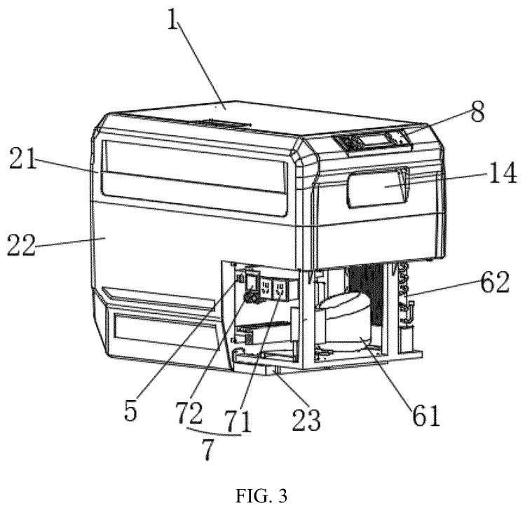

As shown in FIG. 3, the casing 2 includes an upper casing 21, a lower casing 22, and a bottom casing 23, where the upper casing 21 and the lower casing 22 can be two independent components for easy assembly and installation. Of course, the upper casing 21 and the lower casing 22 can also be integrally formed. The upper cover 1 openably and closably covers an upper end of the upper casing 2, a lower part of the inner liner 3 is placed in the lower casing 22 and an upper port is sleeved in the upper casing 21. By opening the upper cover, fruits, drinks, ingredients, etc. can be placed in the inner liner 3 for storage or taken out from the inner liner.

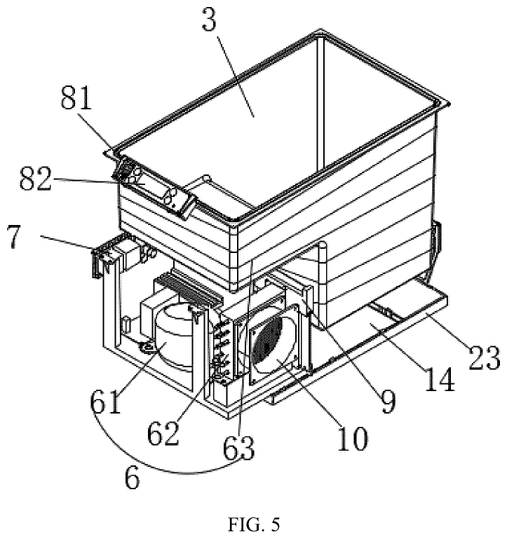

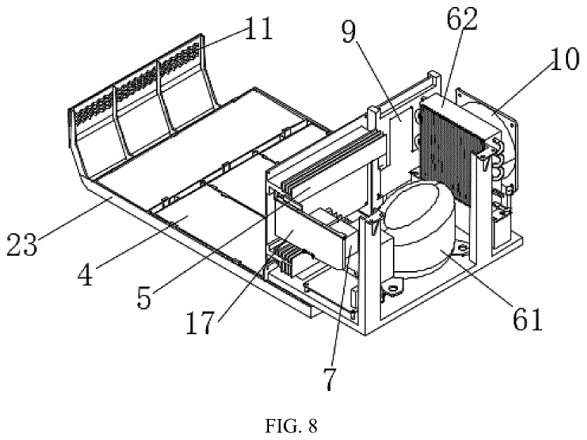

The energy storage unit 4 includes a battery pack and connecting lines, where the battery pack is an electric energy storage device such as a battery or lithium battery that can be charged and discharged multiple times, preferably a lithium battery block. Preferably, as shown in FIGS. 5 and 8, the energy storage unit 4 is also provided with an energy storage unit protection board 9. The energy storage unit protection board 9 detects the voltage of each battery in the battery pack in real time. The energy storage unit protection board 9 is simultaneously connected to a charging line and a discharging line to control the charging and power supply of the battery pack. The battery pack of the energy storage unit is charged with an external Mains supply and an adapter through the energy storage unit protection board. The energy storage unit protection board detects the external charging voltage and the battery pack voltage in real time, and performs protection against excessively high or low voltage during the charging and discharging. Meanwhile, the energy storage unit is allowed to directly supply power to the main control unit through the energy storage unit protection board, the main control unit then outputs various required 24 V, 12 V, and 5 V DC weak currents from a power supply socket as needed, the energy storage unit is allowed to supply power to the inverter unit through the energy storage unit protection board, and then the inverter unit inverts the power into 220 V AC strong currents to supply power to electrical devices that require AC. Preferably, the energy storage unit protection board is also provided with a communication module for real-time communication with the main control board.

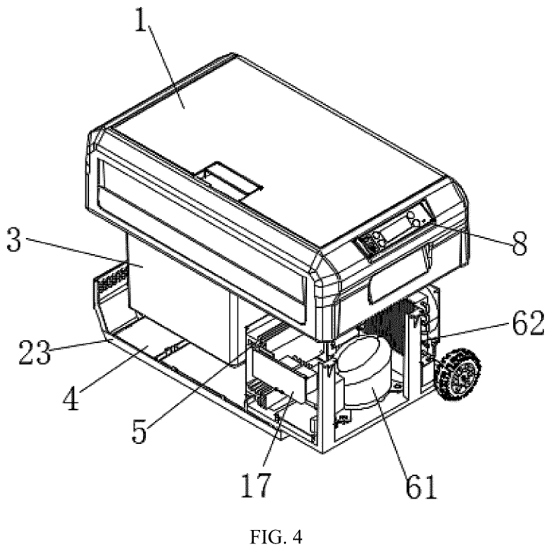

The inverter unit 5 is generally composed of an inverter bridge, control logic, and a filter circuit, and includes an inverter module and a communication module. The refrigeration unit 6 includes a compressor 61, a condenser 62, and an evaporator 63, where the evaporator 63 can be arranged on an outside wall of the inner liner 3 as shown in FIG. 5, or the evaporator 63 can be an inflation evaporator directly placed on an inside wall of the casing 2. The compressor 61, the condenser 62 and the evaporator 63 form a circulating refrigeration for materials in the inner liner. Preferably, the refrigeration unit also includes a throttling device. The power socket unit 7 includes a socket 71 of at least one external electrical device such as cooking or barbecue utensils, which is generally a 220 V voltage socket. Preferably, as shown in FIG. 3, the power socket unit 7 is also provided with a socket switch 72, the inverter unit 5 can be turned on or off through the socket switch 72 to supply power to the socket 71. More preferably, as shown in FIG. 4, a socket cover 17 is provided outside the socket 71 and the switch 72 of the power socket unit 7.

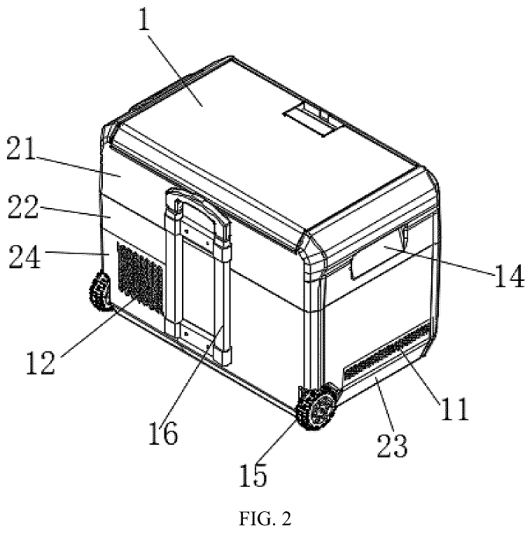

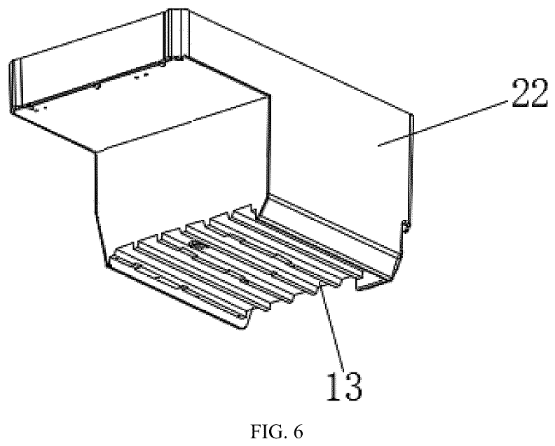

Preferably, as shown in FIGS. 4 and 6, a cavity is provided on one side of the lower casing 22. Of course, the cavity can also be provided on one side of the upper casing 21. The compressor 61 and the condenser 62 of the refrigeration unit 6, the inverter unit 5, and the power socket unit 7 are mounted in the cavity. As shown in FIG. 2, the cavity is covered by the outer cover 24. The parts can be mounted in a centralized manner, the structure is compact, the space occupied is reduced, and the assembly and maintenance are convenient.

The main control unit 8 includes a mainboard box 81, a control mainboard, and a key panel 82, and specially includes an information acquisition part, a display part, a key input part, a communication part, an IC, an output control terminal, etc. The information acquisition part mainly collects information such as ambient temperature, battery pack temperature and voltage, power socket load (current or power), inverter temperature, output power and voltage, and storage inner liner temperature. The communication part mainly includes communication with the inverter unit and the energy storage unit protection board. The main control unit 8 is clamped in a mounting hole at one end of the upper casing 21 through the mainboard box 81, which facilitates installation and operation. In addition, the control mainboard of the main control unit 8 is connected to a USB port and other charging ports for mobile devices such as mobile phones, tablet computers, players, and auxiliary devices such as lighting devices. The main control unit 8 detects parameters (including a voltage value (battery voltage) of an input inverter, an output voltage value, an inverter temperature value, an output current value, etc.) of the refrigeration unit 6, the inverter unit 5 and the energy storage unit 4 in real time, and controls the switching on, shutdown and operation of the refrigeration unit and the power socket unit according to the detected parameters. Preferably, the main control unit controls the switching on, shutdown and operation of the compressor of the refrigeration unit according to the detected parameters, and controls the power supply of the general power socket unit 7 and the inverter unit 5 itself to be turned off or switched on through the inverter unit 5.

Preferably, as shown in FIGS. 2 and 5, the thermal management unit includes a cooling fan 10, an air inlet 11, and an air outlet 12. The air inlet 11 is disposed at one end of the bottom casing 23, and the air outlet 12 is disposed on a side wall of the outer cover 24 close to the condenser 62. Of course, the air inlet 11 and the air outlet can also be disposed separately or individually on the upper casing 22. The main control unit 8 is connected to the cooling fan 10 of the thermal management unit and turns on and shuts down the cooling fan 10 or adjusts a rotational speed of the cooling fan 10 according to the detected parameters of the inverter unit 5, the refrigeration unit and the energy storage unit 4. For example, when the refrigeration unit is cooling rapidly or the refrigeration unit and the power socket unit are using electricity at the same time, the power consumption is increased, which is specifically reflected in the parameters of the inverter unit 5 and the refrigeration unit 6. The main control unit 8 turns on the cooling fan 10 according to the detected parameters of the inverter unit 5 and the refrigeration unit 6 to dissipate heat. When the power socket unit is not supplying power with load or the refrigeration unit has completed refrigeration and is running at a low speed, the main control unit 8 adjusts the rotational speed of the cooling fan 10 or shuts down the cooling fan 10. The power consumption is reduced, and the power supply of the energy storage unit is effectively extended. Preferably, as shown in FIG. 6, a bottom surface of the lower casing 22 is provided with at least one run-through ventilation duct 13, and the arrangement of the ventilation duct 13 can be set according to the positions of the air inlet 11 and the air outlet 12. The ventilation duct can be arranged along a length direction of the bottom surface of the lower casing 22, or along a width direction of the bottom surface of the lower casing 22. The air inlet 11, the ventilation duct 13 and the air outlet 12 constitute a heat dissipation passage in the casing 22, which facilitates the rapid heat dissipation of the parts in the casing, especially the energy storage unit 4, the inverter unit 5 and the refrigeration unit 6. More preferably, the cooling fan 10 is provided outside the condenser 62 and close to the air outlet 12, thereby achieving rapid heat dissipation and cooling in the casing through the heat dissipation passage and the cooling fan, and further protecting the parts and improving the reliability and stability of the operation of each system.

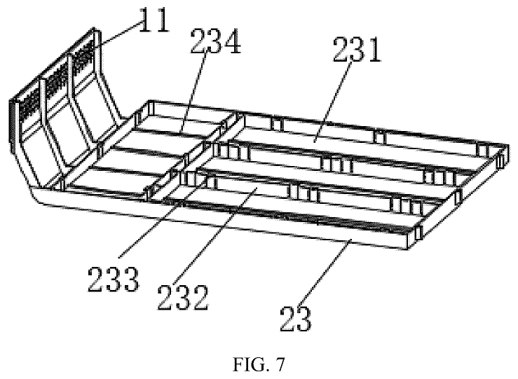

Preferably, as shown in FIG. 7, a bottom surface of a storage groove 231 of the bottom casing 23 is provided with a convex rib 234. Preferably, the convex rib 234 is arranged in a long strip along a length direction of the bottom casing. The energy storage unit 4 is placed on the convex rib 234 and separated from the bottom surface of the storage groove 231 by a gap, which reduces the contact between the energy storage unit 4 and a bottom casing surface, ensures the installation and fixation of the energy storage unit 4, and also allows a part of air entering from the air inlet 11 to pass through the bottom of the energy storage unit 4, thereby more effectively realizing rapid heat dissipation and cooling of the energy storage unit.

Preferably, as shown in FIGS. 4, 7 and 8, the bottom casing 23 is provided with a storage groove 231, a mounting plate 232 is provided in the storage groove 231, and a clip 233 is provided on the mounting plate 232. The energy storage unit 4 (a battery pack in the preferred embodiment of this specification and the accompanying drawings) is clamped in the storage groove 231 by the clip 233, which facilitates the rapid installation of the energy storage unit 4, has a compact structure, reduces occupied space, and meanwhile is convenient to assemble and maintain.

Preferably, a lighting unit is also provided, and the main control unit is connected to the lighting unit to control the lighting unit to turn on, turn off or adjust the brightness of the lighting unit, so as to provide lighting in dark places or at night. Of course, the main control unit can only adjust the brightness of the lighting unit, and the turning on and off the lighting unit can be controlled by an independent switch.

Preferably, as shown in FIG. 1 to FIG. 3, hand placement grooves 14 are respectively provided at both ends of the upper casing 21, and the hand placement grooves 14 facilitate the transportation of the multifunctional mobile energy storage box. More preferably, as shown in FIGS. 1 and 2, wheels 15 are provided at both ends of the bottom of the casing 2, and a pull rod 16 is provided on one side of the casing 2. The wheels 15 and the pull rod 16 facilitate rapid pushing and pulling of the multifunctional mobile energy storage box.

A refrigeration unit and a power socket unit of a multifunctional mobile energy storage box of the present disclosure are powered by the energy storage unit, so that the refrigeration unit can store food in a refrigerated state and the power socket unit can supply power to high-power electrical devices such as cooking and barbecue utensils. Meanwhile, the main control unit detects parameters of the refrigeration unit, the inverter unit and the energy storage unit in real time, and controls the switching on, shutdown and operation of the refrigeration unit and the power socket unit according to the detected parameters to ensure power supply for food storage. It can also meet auxiliary power supply needs such as lighting or playback, and charging of mobile devices, and it takes up little space, meeting people's needs for light-weight and convenient outdoor leisure and relaxation.

Various technical features of the above embodiments can be combined arbitrarily. In order to make the description concise, not all possible combinations of the technical features in the above embodiments are described. However, as long as there is no contradiction in the combination of these technical features, they should be considered to be within the scope described in this specification.

What is claimed is:

1. A multifunctional mobile energy storage box, comprising an upper cover, a casing, an inner liner, an energy storage unit, an inverter unit, a refrigeration unit, a power socket unit, a thermal management unit, and a main control unit, wherein the upper cover openably and closably covers an upper end of the casing, and the inner liner is placed in the casing; the refrigeration unit comprises a compressor, a condenser, and an evaporator, and the evaporator is arranged on an outside wall of the inner liner or placed on an inside wall of the casing; the power socket unit comprises a socket of at least one external electrical device; and the main control unit detects parameters of the energy storage unit, the inverter unit and the refrigeration unit in real time, and controls switching on, shutdown and operation of the refrigeration unit and the power socket unit according to the detected parameters.

2. The multifunctional mobile energy storage box according to claim 1, wherein the casing comprises an upper casing, a lower casing, and a bottom casing, and a lower part of the inner liner is placed in the lower casing and an upper port is sleeved in the upper casing.

3. The multifunctional mobile energy storage box according to claim 2, wherein the upper casing and the lower casing are integrally formed, and the bottom casing is fixedly mounted at the bottom of the lower casing.

4. The multifunctional mobile energy storage box according to claim 2, wherein a cavity is provided on one side of the lower casing or the upper casing, and the compressor and the condenser of the refrigeration unit, the inverter unit, and the power socket unit are mounted in the cavity and covered by an outer cover.

5. The multifunctional mobile energy storage box according to claim 2, wherein the thermal management unit comprises a cooling fan, an air inlet, and an air outlet, the air inlet is arranged at one end of the bottom casing or on the upper casing, the air outlet is arranged on a side wall of the outer cover close to the condenser or on the upper casing, and the main control unit is connected to the cooling fan and turns on or shuts down the cooling fan or adjusts a rotational speed of the cooling fan according to the detected parameters of the inverter unit, the energy storage unit and the refrigeration unit.

6. The multifunctional mobile energy storage box according to claim 5, wherein a bottom surface of the lower casing is provided with at least one run-through ventilation duct, and the air inlet, the ventilation duct and the air outlet constitute a heat dissipation passage.

7. The multifunctional mobile energy storage box according to claim 2, wherein the bottom casing is provided with a storage groove, a mounting plate is provided in the storage groove, a clip is provided on the mounting plate, and the energy storage unit is clamped in the storage groove by the clip.

8. The multifunctional mobile energy storage box according to claim 7, wherein a bottom surface of the storage groove of the bottom casing is provided with a convex rib, and the energy storage unit is placed on the convex rib and separated from the bottom surface of the storage groove by a gap.

9. The multifunctional mobile energy storage box according to claim 1, wherein the energy storage unit is also provided with an energy storage unit protection board, and the charging and power supply of the energy storage unit are controlled by the energy storage unit protection board.

10. The multifunctional mobile energy storage box according to claim 1, wherein a lighting unit is also provided, and the main control unit is connected to the lighting unit to control the lighting unit to be turned on and off or adjust the brightness of the lighting unit.
